(19) United States
(12) Patent Application Publication
(10) Pub. No.: US 2026/0188118 A1
(43) Pub. Date: Jul. 2, 2026

(54) Apparatuses, Systems, and Methods for Parking Space Management

(71) Applicant: Toyota Jidosha Kabushiki Kaisha, Aichi-ken (JP)

(72) Inventors: Anat Litan Sever, Sunnyvale, CA (US); Alexander Granieri, Mountain View, CA (US); Jimmy Chiu, San Jose, CA (US)

(73) Assignee: Toyota Jidosha Kabushiki Kaisha, Aichi-ken (JP)

(21) Appl. No.: 19/003,574

(22) Filed: Dec. 27, 2024

(51) Int. Cl. G08G 1/14; B60W 30/06

(52) U.S. Cl. CPC G08G 1/141; B60W 30/06; B60W 2420/40; B60W 2540/00

(57) ABSTRACT

Systems and methods for parking space management include determining, based on input from a sensor comprising a vision sensor, a position sensor, or a combination thereof, a status of a user in relation to a parked vehicle associated with the user, wherein the parked vehicle is parked in a parking spot, predicting an availability of the parking spot based on the determined status of the user in relation to the parked vehicle, and transmitting a parking availability message based on the predicted availability of the parking spot.

### TECHNICAL FIELD

The present disclosure relates to apparatuses, systems, and methods for vehicle navigation, more specifically, to apparatuses, systems, and methods for vehicle parking location navigation.

### BACKGROUND

Finding a parking space can be a time-consuming challenge, especially in crowded areas or during peak times, due to high demand, limited supply, and traffic congestion. Undesired signage or inefficient parking layouts often make it hard to spot available spaces, while drivers juggle the pressure of finding a spot quickly with cost considerations and proximity to their destination. This often leads to frustration and wasted time circling for an open space. Therefore, there is a need to improve vehicle parking location navigation.

### SUMMARY

In one embodiment, a system for parking space management includes one or more processors, and a non-transitory computer-readable medium having instructions stored thereon. The instructions when executed by the one or more processors cause the system to determine, based on input from a sensor, a status of a user in relation to a parked vehicle associated with the user, wherein the parked vehicle is parked in a parking spot, predict an availability of the parking spot based on the determined status of the user in relation to the parked vehicle, and transmit a parking availability message based on the predicted availability of the parking spot.

In another embodiment, a method for parking space management includes determining, based on input from a sensor comprising a vision sensor, a position sensor, or a combination thereof, a status of a user in relation to a parked vehicle associated with the user, wherein the parked vehicle is parked in a parking spot, predicting an availability of the parking spot based on the determined status of the user in relation to the parked vehicle, and transmitting a parking availability message based on the predicted availability of the parking spot.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an example parking space management system of the present disclosure, according to one or more embodiments shown and described herewith;

FIG. 2 schematically depicts example components of the parking space management system of the present disclosure, according to one or more embodiments shown and described herein; and

FIG. 3 depicts a flowchart of illustrative steps for generating parking availability, according to one or more embodiments shown and described herein.

### DETAILED DESCRIPTION

The disclosed embodiments include apparatuses, systems, and methods for parking space management based on parking availability prediction. The parking availability may be predicted based on a status of a user in related to a parked vehicle associated with the user. The status of the user may include, without limitation, an approaching status, a departing status, an entering status, an existing status, a waiting status, a searching status, or a loading items status. The parking availability may be predicted based on information associated with the user, such as, without limitation, information pertaining to a calendar, an email, a message text, a voicemail of the user. The parking availability may be predicted based on activities of the user, such as, without limitation, paying a parking ticket, moving an item to be loaded into the parked vehicle, putting on sunglasses, or remotely starting the parked vehicle. The parking availability may be predicted based on activities of the parked vehicle, such as, without limitations, automatic start, automatic stop, or autopilot.

Existing methods for managing parking availability rely on a reactive approach, where drivers must physically search for parking spaces, leading to undesired time wastage. Without real-time information or predictive guidance, users often circle around parking lots or crowded streets, unsure of when or where spaces might become available. This lack of visibility not only affects individual drivers but also contributes to broader issues like traffic congestion and environmental harm. Vehicles idling or repeatedly circling for parking emit unnecessary carbon emissions and consume additional fuel. In busy areas, this behavior exacerbates congestion, creating a ripple effect of delays and inefficiencies for other road users. Drivers also face increased stress and frustration due to the unpredictability of parking availability, especially in time-sensitive situations like attending meetings or events. The absence of proactive guidance or reliable availability data makes parking a source of anxiety, particularly in high-demand urban areas. Additionally, this inefficiency often results in underutilized spaces, as the lack of coordination prevents effective turnover and allocation. It is thus difficult to efficiently use parking lot usage.

The disclosed apparatuses, systems, and methods address the aforementioned issues and challenges. Predicting parking availability by leveraging user statuses, contextual information, and specific activities offers a useful approach to improving parking efficiency and user convenience. By tracking statuses such as approaching, departing, waiting, searching, or loading items, systems can predict the likelihood of a parking space becoming available or being needed. For instance, a loading items status may indicate that a parking spot will open. Integrating contextual information, such as user calendars, messages, or emails, adds another layer of prediction. For example, a user with a calendar event near a parking area might trigger a prediction of future demand, while a text about completing an appointment could indicate a departing status. Similarly, voicemail or message content related to errands, meetings, or vehicle use could refine predictions. User activities provide further actionable data points. Actions such as paying a parking ticket at a parking ticket vending machine, starting the vehicle remotely or moving items to be loaded signal imminent departure. Meanwhile, behaviors like putting on sunglasses or adjusting vehicle settings might indicate preparation to leave. By combining these insights, parking systems can offer real-time availability updates, direct users to spaces likely to open soon, and improve the flow of vehicles in high-demand areas. Accordingly, the disclosed apparatuses, systems, and methods reduces search times, minimizes congestion, and enhances overall user satisfaction, while also enabling more efficient management of parking facilities.

Whenever possible, the same reference numerals will be used throughout the drawings to refer to the same or like parts. As used herein, the singular forms “a,” “an” and “the” include plural referents unless the context clearly dictates otherwise. Thus, for example, reference to “a” component includes aspects having two or more such components unless the context clearly indicates otherwise.

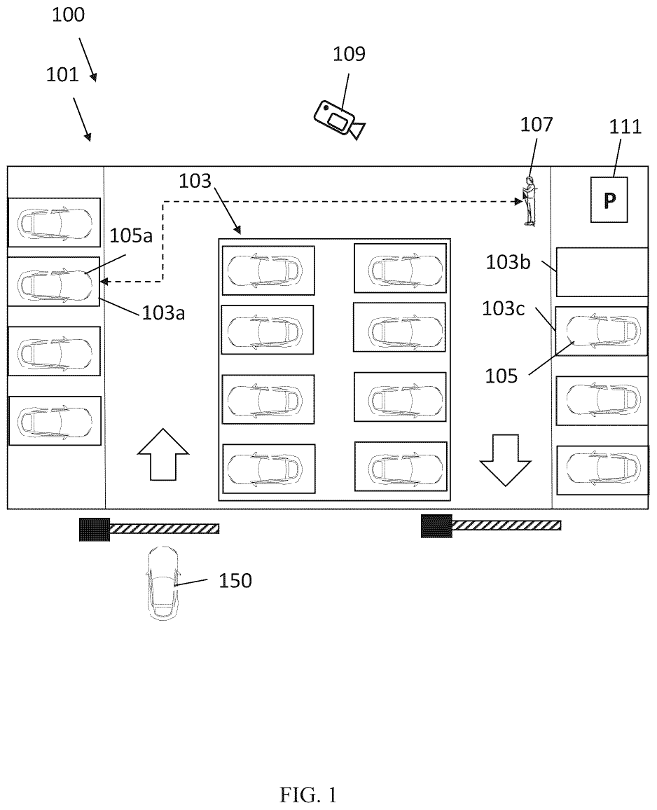

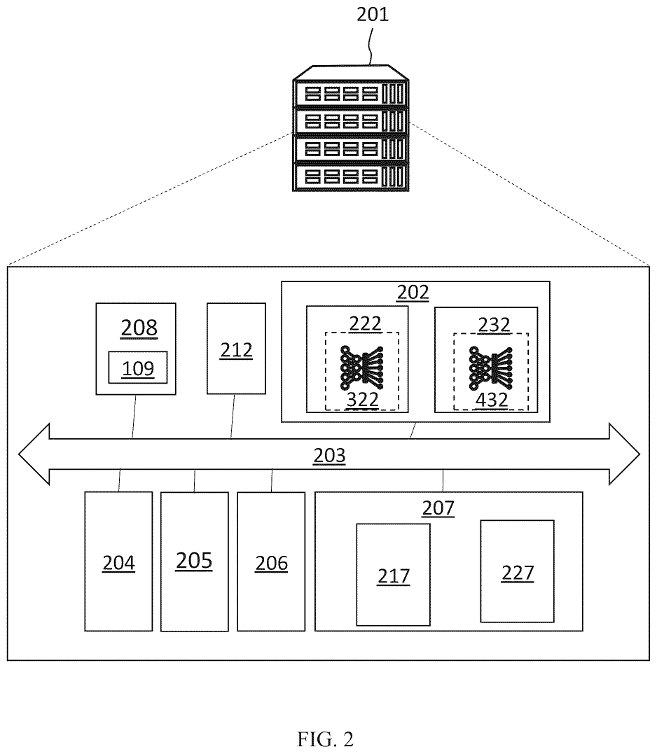

Referring to the figures, FIGS. 1 and 2 schematically depict an example parking space management system 100. The parking space management system 100 may monitor a parking lot 101, such as parking spaces, vehicles, people (e.g., a user 107), and/or objects in or near the parking lot 101. The parking space management system 100 may monitor the parking lot 101 based on sensory data, images, and/or videos, for example, captured by a vision sensor 109. The parking lot 101 may include a plurality of parking spots 103 (e.g., 103a, 103b, and 103c). The parking spots 103 may be occupied by one or more parked vehicles 105. When the parking spot 103 is not occupied, the parking spot 103 is an available parking spot 103b. When the parking spot 103 is occupied, the parking spot 103 is an occupied parking spot 103c. The parking space management system 100 may monitor the occupancy of the parking spots 103, and predict availability of the parking spots 103 of the occupied parking spots 103c. For example, the parking space management system 100 may determine the availability of a parked vehicle 105a associated with the user 107 at a parking spot 103a in the parking lot 101.

Each of the parked vehicles 105 and the coming vehicle 150 may be an automobile or any other passenger or non-passenger vehicle such as, for example, a terrestrial, aquatic, and/or airborne vehicle. Each of the parked vehicles 105 and the coming vehicle 150 may be an autonomous vehicle that navigates its environment with limited human input or without human input. Each of the parked vehicles 105 and the coming vehicle 150 may drive on a road and perform vision-based lane centering, e.g., using one or more sensors. Each of the parked vehicles 105 and the coming vehicle 150 may include actuators for driving the vehicle, such as a motor, an engine, or any other powertrain. The parked vehicles 105 and the coming vehicle 150 may move on various surfaces, such as, without limitations, roads, highways, streets, expressways, bridges, tunnels, parking lots, garages, off-road trails, railroads, or any surfaces where the vehicles may operate.

The parking lot 101 may include the parking spots 103. Each parking spot 103 may be configured to be parked by a parked vehicle 105. In some embodiments, the parking space management system 100 may determine a parking spot 103 as an occupied parking spot or an available parking spot. For example, the parking space management system 100 may include a vision sensor 109 to monitor the occupancy of the parking spots 103 of the parking lot 101. In some embodiments, the parking space management system 100 may receive occupancy information of the parking spots 103. The parking space management system 100 may predict availability of the associated parking spot 103a parked with the associated parked vehicle 105a of the user 107.

In some embodiments, the parking space management system 100 may acquire information regarding one or more users 107 in or near the parking lot 101. For example, the parking space management system 100 may use the vision sensor 109 to monitor the activities of the users 107. In some embodiments, one or more of the users 107 may carry a mobile device such as a smartphone, a key fob, or any other smart device that can communicate with the parking space management system 100, the associated parked vehicles 105a, and/or one or more parked vehicles 105. The smart device, such as the smartphone or the key fob, may include a position sensor configured to monitor the location and moving information of the mobile device. The position sensor may be, without limitation, a global positioning system (GPS) sensor, a Bluetooth low energy (BLE) sensor, an ultra-wideband (UWB) sensor, an accelerometer, or a gyroscope. The mobile device of the user 107 may transmit a current location and moving direction to the parking space management system 100, the associated parked vehicle 105, and/or one or more parked vehicles 105. The user status module 222 may determine the status of the user 107 in relation to the parked vehicle 105a associated with the user 107 based on input from a sensor of the parking space management system 100 (e.g., the vision sensor 109) and/or a sensor associated with the user 107 (e.g., the sensory data generated by the mobile device of the user 107, such as the smartphone and the key fob).

In some embodiments, the parking space management system 100 may include a controller 201. In some embodiments, the controller 201 may be included in the parked vehicles 105 and/or the coming vehicle 150. In some embodiments, the controller 201 may be a remote controller. In some embodiments, the controller 201 may be included in one or more servers including server communication devices, such as network interface hardware 206, operable to communicate with the parked vehicles 105 and the coming vehicle 150. In some embodiments, some of the parked vehicles 105 and the coming vehicle 150 may include communication devices, such as vehicle network interface hardware, operable to wirelessly communicate with the controllers 201.

Referring to FIG. 2, example components of controller 201 are schematically depicted. Although FIG. 2 illustrates one controller 201, in some embodiments, the parking space management system 100 may include one or more controllers 201. The controller 201 may include, without limitation, one or more processors 204, a communication path 203, one or more memory components 202, input/output hardware 205, network interface hardware 206, data storage component 207, and one or more monitoring sensors 208, and/or one or more vehicle sensors 212.

Each of the one or more processors 204 may be any device capable of executing machine-readable and executable instructions. The instructions may be in the form of a machine-readable instruction set stored in data storage component 207 and/or a memory component 202. Accordingly, each of the one or more processors 204 may be a controller, an integrated circuit, a microchip, a computer, or any other computing device. The one or more processors 204 are coupled to the communication path 203 that provides signal interconnectivity between various modules of the system. Accordingly, the communication path 203 may communicatively couple any number of processors 204 with one another, and allow the modules coupled to the communication path 203 to operate in a distributed computing environment. Specifically, each of the modules may operate as a node that may send and/or receive data. As used herein, the term “communicatively coupled” means that coupled components are capable of exchanging data signals with one another such as for example, electrical signals via a conductive medium, electromagnetic signals via air, optical signals via optical waveguides, and the like.

The communication path 203 may be formed from any medium that is capable of transmitting a signal such as for example, conductive wires, conductive traces, optical waveguides, or the like. In some embodiments, the communication path 203 may facilitate the transmission of wireless signals, such as WiFi, Bluetooth®, Near Field Communication (NFC), and the like. Moreover, the communication path 203 may be formed from a combination of mediums capable of transmitting signals. In one embodiment, the communication path 203 comprises a combination of conductive traces, conductive wires, connectors, and buses that cooperate to permit the transmission of electrical data signals to components such as processors, memories, sensors, input devices, output devices, and communication devices. Accordingly, the communication path 203 may comprise a vehicle bus, such as for example a LIN bus, a CAN bus, a VAN bus, and the like. Additionally, it is noted that the term “signal” means a waveform (e.g., electrical, optical, magnetic, mechanical, or electromagnetic), such as DC, AC, sinusoidal wave, triangular wave, square wave, vibration, and the like, capable of traveling through a medium.

The one or more memory components 202 may be coupled to the communication path 203. The one or more memory components 202 may include RAM, ROM, flash memories, hard drives, or any device capable of storing machine-readable and executable instructions such that the machine-readable and executable instructions can be accessed by the one or more processors 204. The machine-readable and executable instructions may include logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine-readable and executable instructions and stored on the one or more memory components 202. Alternatively, the machine-readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

The one or more memory components 202 may include one or more modules, such as the user status module 222 and the user indicator module 232. Each of the one or more modules may include, without limitation, routines, subroutines, programs, objects, components, data structures, and the like for performing specific tasks or executing specific data types as will be described below. The data storage component 207 may store map data including, without limitations, the parking lot 101, the parking spots 103, the parked vehicles 105, the coming vehicle 150, the waiting vehicles, the parking ticket vending machine 111, and/or the users 107 associated with the parked vehicles 105. The data storage component 207 may further store training data 227 for training the user status module 222 and the user indicator module 232. The data storage component 207 may store historical data 217, such as, without limitation, historical user status, historical departure, historical sensory data, and/or historical vehicle data related to operation of the parked vehicles 105. The user status module 222 and the user indicator module 232 may also be stored in the data storage component 207 during operating or after the operation.

The one or more modules, including the user status module 222 and the user indicator module 232, may include one or more machine-learning algorithms, such as neural networks. The modules may be trained and provided with machine learning capabilities via a neural network as described herein. By way of example, and not as a limitation, the neural network may utilize one or more artificial neural networks (ANNs). In ANNs, connections between nodes may form a directed acyclic graph (DAG). ANNs may include node inputs, one or more hidden activation layers, and node outputs, and may be utilized with activation functions in the one or more hidden activation layers such as a linear function, a step function, logistic (Sigmoid) function, a tanh function, a rectified linear unit (ReLu) function, or combinations thereof. ANNs are trained by applying such activation functions to training data sets to determine an optimized solution from adjustable weights and biases applied to nodes within the hidden activation layers to generate one or more outputs as the optimized solution with a minimized error. In machine learning applications, new inputs may be provided (such as the generated one or more outputs) to the ANN model as training data to continue to improve accuracy and minimize error of the ANN model. The one or more ANN models may utilize one-to-one, one-to-many, many-to-one, and/or many-to-many (e.g., sequence-to-sequence) sequence modeling. The one or more ANN models may employ a combination of artificial intelligence techniques, such as, but not limited to, Deep Learning, Random Forest Classifiers, Feature extraction from audio, images, clustering algorithms, or combinations thereof. In some embodiments, a convolutional neural network (CNN) may be utilized. For example, a convolutional neural network (CNN) may be used as an ANN that, in the field of machine learning, for example, is a class of deep, feed-forward ANNs applied for audio analysis of the recordings. CNNs may be shift or space-invariant and utilize shared-weight architecture and translation. Further, each of the various modules may include one or more generative artificial intelligence algorithms. The generative artificial intelligence algorithm may include a generative adversarial network (GAN) that has two networks, a generator model and a discriminator model. The generative artificial intelligence algorithm may also be based on variation autoencoder (VAE) or transformer-based models. Each of the various modules may include one or more large language model (LLM) algorithms. The LLM algorithm may include one or more neural network layers, such as, without limitation, a recurrent layer, a feedforward layer, an embedding layer, and/or an attention layer, to process input (e.g., input text) and generate output.

The input/output hardware 205 may be coupled to the communication path 203. The input/output hardware 205 may include a monitor, keyboard, mouse, printer, camera, microphone, speaker, and/or other device for receiving, sending, and/or presenting data. The controller 201 may include network interface hardware 206 for communicatively coupling the controller 201 to external resources (e.g., the parked vehicles 105 and the coming vehicle 150 or smart devices), Internet of Things (IoTs), and/or a server. The network interface hardware 206 can be communicatively coupled to the communication path 203 and can be any device capable of transmitting and/or receiving data via a network. Accordingly, the network interface hardware 206 can include a communication transceiver for sending and/or receiving any wired or wireless communication. For example, the network interface hardware 206 may include an antenna, a modem, LAN port, WiFi card, WiMAX card, mobile communications hardware, near-field communication hardware, satellite communication hardware, and/or any wired or wireless hardware for communicating with other networks and/or devices. In one embodiment, the network interface hardware 206 includes hardware configured to operate in accordance with the Bluetooth® wireless communication protocol. For example, the network interface hardware 206 of the parking space management system 100 may receive and/or transmit map data of the parking lot 101, planned route, availability time of the parking spots, sensory data of the parked vehicles 105 and/or the coming vehicle 150 (such as, speed data, acceleration data, steering data, yaw data, wheel slip data, lane departure data, time-of-day, weather conditions, vehicle type, vehicle size, minimum and maximum vehicle turning radii) with a server or the parked vehicles 105 and the coming vehicle 150.

The controller 201, the parked vehicles 105, and/or the coming vehicle 150 may include one or more monitoring sensors 208 and vehicle sensors 212. The monitoring sensors 208 and the vehicle sensors 212 may be coupled to the communication path 203. The monitoring sensors 208 may include the vision sensor 109 and the position sensor. The position sensor may be, without limitation, a GPS sensor, a BLE sensor, a UWB sensor, an accelerometer, or a gyroscope. The BLE sensor may estimate proximity by measuring the strength of the signal, known as the Received Signal Strength Indicator (RSSI), for example, between the user's mobile device and the vehicle's BLE-enabled system. The UWB sensor may calculate a relative distance based on time-of-flight (ToF) of UWB signals, for example, for the signal to travel between the user's device and the vehicle to determine the distance based on the speed of light. The vision sensor 109 may be used for capturing images or videos of the environment around the parking lot 101, the parked vehicles 105, and/or the coming vehicle 150. In some embodiments, the one or more monitoring sensors 208 include one or more vision sensors 109. The vision sensors 109 may be imaging sensors configured to operate in the visual and/or infrared spectrum to sense visual and/or infrared light. Additionally, while the particular embodiments described herein are described with respect to hardware for sensing light in the visual and/or infrared spectrum, it is to be understood that other types of sensors are contemplated. For example, the systems described herein could include one or more LIDAR sensors, radar sensors, sonar sensors, or other types of sensors for gathering data that could be integrated into or supplement the data collection described herein. Ranging sensors like radar may be used to obtain rough depth and speed information for the view of the parked vehicle 105 and/or the coming vehicle 150. The one or more monitoring sensors 208 may include a forward-facing camera installed in the parked vehicles 105 and/or the coming vehicle 150. The one or more monitoring sensors 208 may be any device having an array of sensing devices capable of detecting radiation in an ultraviolet wavelength band, a visible light wavelength band, or an infrared wavelength band. The one or more monitoring sensors 208 may have any resolution. In some embodiments, one or more optical components, such as a mirror, fish-eye lens, or any other type of lens may be optically coupled to the one or more monitoring sensors 208. In embodiments described herein, the one or more monitoring sensors 208 may provide image data to the one or more processors 204 or another component communicatively coupled to the communication path 203. In some embodiments, the one or more monitoring sensors 208 may also provide navigation support. That is, data captured by the one or more monitoring sensors 208 may be used to autonomously or semi-autonomously navigate a vehicle, such as the parked vehicle 105 and/or the coming vehicle 150.

The controller 201, the parked vehicles 105, and/or the coming vehicle 150 may include one or more vehicle sensors 212. Each of the one or more vehicle sensors 212 is coupled to the communication path 203 and communicatively coupled to the one or more processors 204. The one or more vehicle sensors 212 may include one or more speed sensors or motion sensors for detecting and measuring motion and changes in motion of a vehicle, e.g., the parked vehicles 105, and/or the coming vehicle 150. The motion sensors may include inertial measurement units. Each of the one or more motion sensors may include one or more accelerometers and one or more gyroscopes. Each of the one or more motion sensors transforms the sensed physical movement of the vehicle into a signal indicative of an orientation, a rotation, a velocity, or an acceleration of the vehicle. The acquired data from the vehicle sensors 212 may be used to determine the vehicle kinematics of the parked vehicles 105 and/or the coming vehicle 150.

The monitoring sensors 208 and the vehicle sensors 212 may be used to collect vehicle control data, road condition data, and vehicle kinematic data. The vehicle control data, the road condition data, and the vehicle kinematic data may be used to monitor an actual trajectory of the parked vehicles 105 and/or the coming vehicle 150, including whether the vehicle is parked at a desired parking spot 103. The vehicle control data may include throttle position, brake status, steering angle, and gear selection of the parked vehicles 105 and/or the coming vehicle 150. The road condition data may include road type, friction coefficient, and surface irregularities (e.g., bumps). The vehicle kinematic data may include velocity, acceleration, position, and orientation of the parked vehicles 105 and/or the coming vehicle 150.

In some embodiments, the controller 201 may further include one or more modules, such as a user status module 222 and a user indicator module 232. The user status module 222 may include one or more first machine-learning algorithms, such as a first neural network 322. The user status module 222 may generate a status of the user 107 in relation to a parked vehicle 105a associated with the user 107 at a parking spot 103a in the parking lot 101. The parking space management system 100 may predict an availability of the parking spot 103a based on the determined status of the user 107 in relation to the parked vehicle 105a. The parking space management system 100 may transmit a parking availability message based on the predicted availability of the parking spot 103a. In some embodiments, the system may transmit parking availability information to a coming vehicle 150. The coming vehicle 150 may seek an available parking spot 103b in the parking lot 101.

In some embodiments, the user status module 222 may determine the status of the user 107 at least partially based on a relative distance between the user 107 and the parked vehicle 105a. The status of the user 107 in relation to the parked vehicle 105a may include, with limitation, an approaching status, a departing status, an entering status, an existing status, a waiting status, a searching status, and/or a loading items status. The approaching status refers to a user status when the user 107 is moving toward the associated parked vehicle 105a with intent to leave. The user status module 222 may determine the approaching status based on, without limitation, a decreasing relative distance between the user 107 and the parked vehicle 105a, or interactions such as unlocking the parked vehicle 105a or engaging with a smart key of the parked vehicle 105a. The departing status refers to a user status where the user 107 is in or near the parked vehicle 105a and exhibiting behaviors that indicate an intent to leave. For instance, the user 107 may start the engine, engage reverse gear, or otherwise prepare to drive away. The user status module 222 may detect these actions via data generated by in-car sensors or app-based interactions. The entering status refers to a user status where the user 107 has just parked and is leaving the parked vehicle 105a. The entering status indicates that the parking spot 103a is occupied and unavailable. The user status module 222 may determine the entering status based on, without limitation, the user locking the parked vehicle 103a and walking away from the parked vehicle 103a, as indicated by the position location becoming stationary in relation to the parked vehicle 105a. The existing status refers to a user status when the user 107 is away from the parked vehicle 105a, and the parked vehicle 105a remains stationary. The existing status may indicate the parking spot is occupied with no immediate signs of departure. The user status module 222 may determine the existing status based on user activities, such as, the location information being far from the parked vehicle 105a and absence of recent vehicle interactions. The waiting status refers to a user status where the user 107 is near the parked vehicle 105a but is not actively showing signs of leaving or staying. For example, the user 107 may be standing nearby or sitting inside the car without engaging the engine or driving away. The searching status refers to a user status where the user 107 is preparing to vacate the parking spot 103a but has not yet begun to leave. The searching status may involve actions like retrieving items from the vehicle, opening the trunk, or moving back and forth near the parked vehicle 105a in a preparatory manner. The loading items status refers to a user status where the user 107 actively loads or unloads items from the parked vehicle 105a. The loading items status may indicate the user 107 is about to leave but is first completing a task, such as placing groceries in the trunk or unloading luggage. The user status module 222 may determine the loading items status based on door or trunk activity paired with the proximity of the user 107 to the parked vehicle 105a. The loading items status may suggest the parking spot 103a might be vacated shortly, depending on how long the user 107 spends on their activity. In some embodiments, the user status module 222 may use the neural network 322 to determine the user status of the user status.

In some embodiments, the parking space management system 100 may receive information associated with the user 107. The information may include, without limitation, one or more calendars, one or more emails, one or more message texts, and/or one or more voicemails of the user 107. The user indicator module 232 may include a large language model (LLM) algorithm 432. The parking space management system 100 may use the LLM algorithm 432 to predict the availability of the parking spot 103a based on information associated with the user 107. The LLM algorithm 432 may be built on deep neural networks, such as a transformer architecture. This architecture may use self-attention mechanisms to capture context within text. In operation, in some embodiments, the LLM algorithm 432 may predict the availability of the parking spot 103a availability by processing information associated with the user 107. The LLM algorithm 432 may analyze contextual data linked to the user 107, such as, without limitation, calendar events, emails, text messages, and voicemails. For example, a calendar event might indicate a scheduled meeting, suggesting a future departure, while emails or text messages could hint at imminent plans to vacate or occupy a parking spot. By analyzing this data associated with the user 107, the user indicator module 232 can extract relevant details and infer behavioral patterns, such as when the user 107 might return to or leave their vehicle. In some embodiments, after the user information is received, the user indicator module 232 may process the data to identify patterns and predict outcomes. For instance, if the calendar of the user 107 indicates an event at a distant location starting soon, or a message includes phrases like “I'm heading out,” the user indicator module 232 may interpret this as a high likelihood of departure. Conversely, if the data shows the user 107 is stationary or does not indicate any activity near the parked vehicle 105a, the user indicator module 232 may conclude that the parking spot 103a may remain occupied. The LLM algorithm 432 may identifying patterns in communication used to anticipate the next destination of the user 107 (e.g., scheduled meetings or regular visits to certain places at specific times). By integrating its understanding of context, the LLM algorithm 432 can transform unstructured input into actionable insights about parking spot availability. The predictions generated by the user indicator module 232 may be used to update the availability of the parking spot 103a associated with the user 107, such as marking the availability as “available soon” or “occupied.” This information can be relayed to other users 107 or systems, enabling dynamic parking management. For example, drivers searching for parking can receive real-time updates, while parking operators can optimize allocation based on anticipated spot availability.

In some embodiments, the parking space management system 100 may predict the availability of the parking spot 103a based on an activity of the user 107. The activity of the user 107 may include, without limitation, paying a parking ticket, moving an item to be loaded into the parked vehicle 105a, putting on sunglasses, or remotely starting the parked vehicle 105a. For instance, paying a parking ticket could suggest that the user 107 is finalizing their use of the parking space and may be preparing to leave. Similarly, moving an item to be loaded into the parked vehicle 105a may indicate the user 107 is engaged in preparatory activities associated with a high probability of departure. Other subtle actions, such as putting on sunglasses, could suggest readiness for travel, especially in conditions like bright sunlight. Additionally, remotely starting the parked vehicle 105a may indicate a high probability of imminent departure.

In some embodiments, the parking space management system 100 may predict the availability of the parking spot based on an activity of the parked vehicle 105a. The activity of the parked vehicle 105a may include, without limitation, automatic start, automatic stop, or autopilot. For example, an automatic start may indicate that the user 107 initiates the parked vehicle 105a remotely, typically as part of preparation to depart the parking spot 103a. Conversely, an automatic stop feature may deactivate the engine after prolonged inactivity, suggesting that the parked vehicle 105a may be stationary and the parking spot 103a is likely to remain occupied. Additionally, the use of autopilot or self-driving capabilities in the parked vehicle 105a may provide another layer of predictive data. For instance, if the autopilot system of the parked vehicle 105a is engaged and indicates that the parked vehicle 105a is readying to navigate away from its current location, the parking space management system 100 may determine a high probability that the parking spot 103a will soon become available. These vehicle-specific actions, especially when combined with user activities (e.g., moving items or paying for parking), provide robust and contextual insights into spot availability.

In some embodiments, after determining the probability of availability for the parking spot 103a, the parking space management system 100 may take proactive actions to optimize parking allocation and vehicle routing. For example, when the probability of availability exceeds a predefined availability threshold value (e.g., greater than or equal to 0.5, 0.6, 0.7, 0.8, 0.9, or 1, or any value between 0.5 and 1), the parking space management system 100 may initiate specific operations. For instance, the parking space management system 100 may generate a route to the parking spot 103a for the coming vehicle 150 and instruct the coming vehicle 150 to operate autonomously or semi-autonomously along the specified route. Additionally, the parking space management system 100 may disseminate a parking availability message to a plurality of waiting vehicles, providing them with real-time updates about the availability of the parking spot 103a. In some embodiments, among these waiting vehicles, the parking space management system 100 may select a first waiting vehicle to occupy the parking spot. The selection process may prioritize vehicles based on various criteria, including their proximity, estimated time of arrival, or position in a queue on a waiting list. This ensures fair and efficient allocation of the parking spot to the most suitable candidate. In some embodiments, the parking space management system 100 enhances the selection process by estimating the available time of the parking spot 103a, involving predicting when the parked vehicle 105a is likely to vacate the spot, enabling the parking space management system 100 to align the estimated availability with the arrival time of waiting vehicles. The available time may be determined based on, without limitation, the proximity of the user 107 to the parked vehicle 105a, historical data regarding the departure of user 107 in the parking lot 101, and/or historical departure data of general users. For example, the parking space management system 100 may prioritize selecting the first waiting vehicle that is predicted to arrive closest to the estimated availability time, minimizing idle time, and maximizing parking lot 101 efficiency.

Referring back to FIG. 2, in embodiments, the user status module 222 and the user indicator module 232 may include one or more neural networks 322 and 432. Each of the neural networks 322 and 432 may include an encoder, one or more layers of hidden layers, and a decoder. The neural networks may feed training data 227 during the pre-training process into the encoder to generate a lower-dimensional representation of the target input-output pairs. For example, the lower-dimensional representation may include the input of sensory data collected using the vision sensor 109 and the position sensor pairing with user status and/or availability of parking spot of the parked vehicles 105 and the user 107. The first neural network 322 may output user status of the user 107. The second neural network, such as the LLM algorithm 432, may output availability of the parking spots 103 and/or available time of the parking spots 103.

In some embodiments, the user status module 222 and the user indicator module 232 may include one or more neural networks 322 and 432 having been trained with the training data 227 and the historical data 217. The neural networks 322 and 432 may include the encoder or/and the decoder conjunct with a layer normalization operation or/and an activation function operation. The encoded input data may be normalized and weighted through the activation function before being fed to the hidden layers. The hidden layers may generate a representation of the input data at a bottleneck layer. After delivering neural-network processed data to the final layer of the neural network, a global layer normalization may be conducted to normalize the user status, probability of the availability of the parking lots, the available time of the parking lots. The outputs may be normalized and converted using an activation function for training and verification purposes, as described in detail further below. The activation function may be linear or nonlinear. The activation function may be, without limitations, a Sigmoid function, a Softmax function, a hyperbolic tangent function (Tanh), or a rectified linear unit (ReLU). The neural networks 322 and 432 may feed the encoder with historical data 217, such as, without limitation, historical user status, historical departure, historical sensory data, and/or historical vehicle data related to the operation of the parked vehicles 105, and other historical parking lot data for continuation training.

In some embodiments, the user status module 222 and the user indicator module 232 may be pre-trained using training data 227, including ground-truth examples and scenarios where multiple entities (e.g. the parked vehicles 105 and the coming vehicle 150, the waiting vehicles, the users 107, and/or the objects in the parking lot 101) in or near the parking lot 101. The pre-training may include labeling the entities and desirable user status, parking availability, and/or available time based on the entities and parking lot data in the examples and scenarios and using one or more neural networks 322 and 432 to learn to predict the desirable and undesirable user status, parking availability, and/or available time based on the training data 227. The pre-training may further include fine-tuning, evaluation, and testing steps. The modules may be continuously trained using the real-world collected data as the historical data 217 to adapt to changing conditions and factors and improve the performance over time. The neural network, including the LLM algorithm 432, may be trained based on the activation functions mentioned further above. The encoder may generate encoded input data h=(Wx+b) that is transformed from the input data of one or more input channels. The encoded input data of one of the input channels may be represented as hᵢⱼ=g(Wxᵢⱼ+b) from the raw input data xᵢⱼ, which is then used to reconstruct output \tilde{x}ᵢⱼ=f(W^{T}hᵢⱼ+b′) . The neural networks may reconstruct outputs, such as user status, parking availability, and/or available time, into x′=(W^{T}h+b′), where W is weight, b is bias, W^{T} and b′ are transverse values of W and b and are learned through backpropagation. In this operation, the neural networks may calculate, for each input data, the distance between an input data x and a reconstructed input data x′, to yield a distance vector |x−x′|. The neural networks 322 and 432 may minimize the loss function which is a utility function as the sum of all distance vectors. The training process may enable the neural networks 322 and 432 to learn linear or non-linear representations of the input data. The accuracy of the predicted output may be evaluated by satisfying a preset value, such as a preset accuracy and area under the curve (AUC) value computed using an output score from the activation function (e.g. the Softmax function or the Sigmoid function). For example, the parking space management system 100 may assign the preset value of the AUC with the value of 0.7 to 0.8 as an acceptable simulation, 0.8 to 0.9 as an excellent simulation, or more than 0.9 as an outstanding simulation. After the training satisfies the preset value, the updated neural networks 322 and 432 may be stored in the user status module 222 and the user indicator module 232, respectively, which are used to generate future planned trajectories and optimal turning paths.

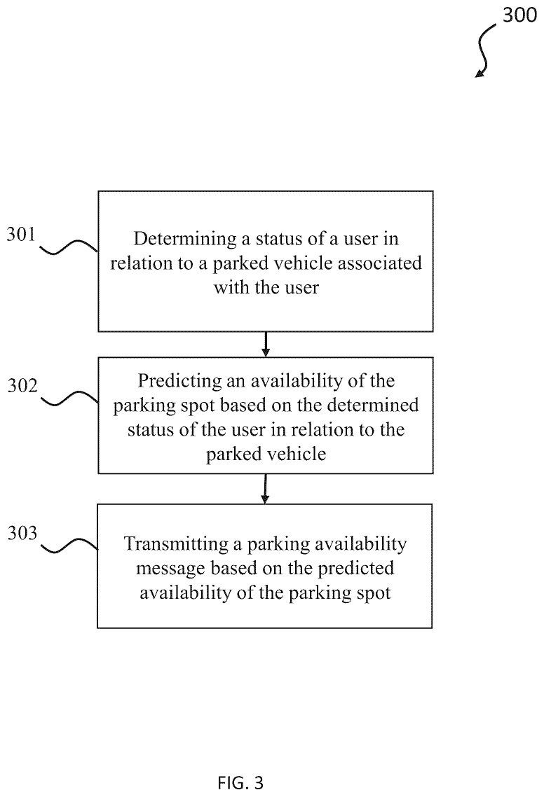

Referring to FIG. 3, a flowchart of method 300 for parking space management is depicted. At block 301, the method 300 includes determining, based on input from a sensor, a status of a user 107 in relation to a parked vehicle 105a associated with the user 107. The parked vehicle 105a is parked in a parking spot 103a. The sensor may include a vision sensor 109, a position sensor, or a combination thereof. At block 302, the method 300 includes predicting an availability of the parking spot 103a based on the determined status of the user 107 in relation to the parked vehicle 105a. At block 303, the method 300 includes transmitting a parking availability message based on the predicted availability of the parking spot 103a.

In some embodiments, the status of the user 107 in relation to the parked vehicle 105a may include an approaching status, a departing status, an entering status, an existing status, a waiting status, a searching status, a loading items status, or a combination thereof. The status of the user may be at least partially determined based on a relative distance between the user 107 and the parked vehicle 105a.

In some embodiments, the method 300 may include predicting, using a neural network including the LLM algorithm 432, the availability of the parking spot 103a based on information associated with the user 107. The information may include, without limitation, a calendar, an email, a message text, a voicemail, or a combination thereof. The method 300 may include predicting the availability of the parking spot 103a based on an activity of the user 107. The activity of the user 107 may include, without limitation, paying a parking ticket, moving an item to be loaded into the parked vehicle 105a, putting on sunglasses, remotely starting the parked vehicle, automatic start, automatic stop, autopilot, or a combination thereof.

In some embodiments, the method 300 may include generating a route to the parking spot for an ego vehicle, and instructing the ego vehicle to operate according to the route.

In some embodiments, the method 300 may include transmitting the parking availability message of the parking spot 103a to a plurality of waiting vehicles, and selecting a first waiting vehicle out of the waiting vehicles to park in the parking spot 103a. The method 300 may include estimating an available time of the parking spot 103a, and selecting the first waiting vehicle based on an arrival time of the first waiting vehicle and the available time of the parking spot 103a or based on a queue of a waiting list associated with the waiting vehicles.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system for parking space management comprising:
one or more processors; and
a non-transitory computer-readable medium having instructions stored thereon, which when executed by the one or more processors cause the system to:
determine, based on input from a sensor, a status of a user in relation to a parked vehicle associated with the user, wherein the parked vehicle is parked in a parking spot;
predict an availability of the parking spot based on the determined status of the user in relation to the parked vehicle; and
transmit a parking availability message based on the predicted availability of the parking spot.

2. The system of claim 1, wherein the status of the user in relation to the parked vehicle comprises an approaching status, a departing status, an entering status, an existing status, a waiting status, a searching status, a loading items status, or a combination thereof.

3. The system of claim 1, wherein the status of the user is at least partially determined based on a relative distance between the user and the parked vehicle.

4. The system of claim 1, wherein the system comprises a neural network, and the instructions further cause the system to use the neural network to predict the availability of the parking spot.

5. The system of claim 4, wherein the neural network comprises a large language model (LLM) algorithm, and the instructions further cause the system to:
predict, using the LLM algorithm, the availability of the parking spot based on information associated with the user.

6. The system of claim 5, wherein the information comprises a calendar, an email, a message text, a voicemail, or a combination thereof.

7. The system of claim 1, wherein the availability of the parking spot is predicted further based on an activity of the user, the activity of the user comprising paying a parking ticket, moving an item to be loaded into the parked vehicle, putting on sunglasses, remotely starting the parked vehicle, or a combination thereof.

8. The system of claim 1, wherein the availability of the parking spot is predicted further based on an activity of the parked vehicle, the activity of the parked vehicle comprising automatic start, automatic stop, autopilot, or a combination thereof.

9. The system of claim 1, wherein the sensor comprises a vision sensor, a position sensor, or a combination thereof.

10. The system of claim 1, wherein the instructions further cause the system to:
generate a route to the parking spot for an ego vehicle; and
instruct the ego vehicle to operate according to the route.

11. The system of claim 1, wherein the instructions further cause the system to:
transmit the parking availability message of the parking spot to a plurality of waiting vehicles; and
select a first waiting vehicle out of the waiting vehicles to park in the parking spot.

12. The system of claim 11, wherein the instructions further cause the system to:
estimate an available time of the parking spot; and
select the first waiting vehicle based on an arrival time of the first waiting vehicle and the available time of the parking spot.

13. The system of claim 11, wherein the instructions further cause the system to:
select the first waiting vehicle based on a queue of a waiting list associated with the waiting vehicles.

14. A method for parking space management comprising:
determining, based on input from a sensor comprising a vision sensor, a position sensor, or a combination thereof, a status of a user in relation to a parked vehicle associated with the user, wherein the parked vehicle is parked in a parking spot;
predicting an availability of the parking spot based on the determined status of the user in relation to the parked vehicle; and
transmitting a parking availability message based on the predicted availability of the parking spot.

15. The method of claim 14, wherein:
the status of the user in relation to the parked vehicle comprises an approaching status, a departing status, an entering status, an existing status, a waiting status, a searching status, a loading items status, or a combination thereof; and
the status of the user is at least partially determined based on a relative distance between the user and the parked vehicle.

16. The method of claim 14, further comprises:
predicting, using a neural network comprising a large language model (LLM) algorithm, the availability of the parking spot based on information associated with the user, wherein the information comprises a calendar, an email, a message text, a voicemail, or a combination thereof.

17. The method of claim 14, further comprises:
predicting the availability of the parking spot based on an activity of the user, the activity of the user comprising paying a parking ticket, moving an item to be loaded into the parked vehicle, putting on sunglasses, remotely starting the parked vehicle, automatic start, automatic stop, autopilot, or a combination thereof.

18. The method of claim 14, further comprises:
generating a route to the parking spot for an ego vehicle; and
instructing the ego vehicle to operate according to the route.

19. The method of claim 14, further comprises:
transmitting the parking availability message of the parking spot to a plurality of waiting vehicles; and
selecting a first waiting vehicle out of the waiting vehicles to park in the parking spot.

20. The method of claim 19, further comprises:
estimating an available time of the parking spot; and
selecting the first waiting vehicle based on an arrival time of the first waiting vehicle and the available time of the parking spot or based on a queue of a waiting list associated with the waiting vehicles.
